(19) United States
(12) Patent Application Publication
(10) Pub. No.: US 2016/0189194 A1
(43) Pub. Date: Jun. 30, 2016

(54) Computer implemented system and method for creation of a digital,collaborative review platform, network and publication

(71) Applicants: Alex Minicucci, San Luis Obispo, CA (US); Luke A. Wallace, San Luis Obispo, CA (US)

(72) Inventors: Alex Minicucci, San Luis Obispo, CA (US); Luke A. Wallace, San Luis Obispo, CA (US)

(21) Appl. No.: 14/544,388

(22) Filed: Dec. 31, 2014

(51) Int. Cl. G06Q 30/02

(52) U.S. Cl. CPC G06Q 30/0226

(57) ABSTRACT

A computer implemented system and method for creation of a digital, collaborative review platform, network and publication system through a loyalty based kiosk platform for obtaining reviews from select customers in response to a text inquiry. The select customers may obtain loyalty credits or other incentives for providing reviews within a period of time and may become leaders and followed persons. The results of the reviews may be further used to obtaining information about members of a consumer base, may be filtered, analyzed, compiled and otherwise employed prior to publishing and may be posted to a multiplicity of social network sites or separately published as a standalone platform/site which may only be accessed by loyalty kiosk members.

### FIELD OF THE INVENTION

The present invention related to a computer implemented system and method for creation of a digital, collaborative review platform, network and publication system through a loyalty based kiosk platform for obtaining reviews from select customers in response to a text inquiry. The select customers may obtain loyalty credits or other incentives for providing reviews within a period of time and may become leaders and followed persons. The results of the reviews may be further used to obtaining information about members of a consumer base, may be filtered, analyzed, compiled and otherwise employed prior to publishing and may be posted to a multiplicity of social network sites or separately published as a standalone platform/site which may only be accessed by loyalty kiosk members.

The present invention further relates to the field of marketing and the delivery of text messages following the entry of data by a customer via a loyalty kiosk and associated non-transitory computer-readable storage media having computer-executable instructions embodied, thereon situated within a business environment. The customer data and loyalty kiosk check-in is used in SMS/text generation campaigns to obtain reviews and related data from selected customers that can be employed in conjunction with a social media and/or loyalty network series of postings or may be separately published for use solely by the members of the loyalty kiosk network. The system and method further provide dissemination of the review/response campaigns through social network interfaces and data/status updates of the review/response campaign based on review/response designated triggers, filters and engines.

The present invention further relates to the field of interactive marketing and data acquisition to permit such marketing in particular, but not limited to, in publishing of reviews that are specific to enterprises that form part of the loyalty kiosk marketing and data acquisition system. The platform may use any of a number of communication systems and ideally uses short message services (SMS) provided on mobile devices such as cell phones or other telecommunication systems permitting SMS or other short code transmissions.

The present invention further relates to a method and system for generating enterprise reviews that may be relied upon as being based upon a reviewer's actual use of a loyalty kiosk and participation within the loyalty kiosk network system within a defined but variable period of time from the reviewer's checking in to the loyalty kiosk, by generation of a marketing query and request for a critique of a customer's experience at the enterprise associated with the specific loyalty kiosk.

Customer feedback is valuable information for service and product providers, governmental and non-profit organizations, and other types of businesses. However, research conducted for the White House Office of Consumer Affairs from 1978-1986, based on a cross-sectional survey of the US population, confirms that most consumers choose not to provide feedback for a variety of reasons. “Consumer Complaint Handling in America: An Update Study,” provided under U.S. Government Contract No. HHS-100-84-0065.

Furthermore, what limited feedback is provided is often difficult to analyze and may not provide simple methods by which the provider can respond to the consumer. It is well-known that current review/response systems that permit laudatory or complaint reviews and/or feedback mechanisms present a number of barriers to easy communication between consumers and providers. Strategic Customer Service, ISBN-13:978-0-8144-1333-3, AMACOM, American Management Association (NY, N.Y. 2009).

There is an issue of trust on review sites on the Internet today. People can't always trust the reviews and ratings they read. People don't know who the reviewers are. People don't know if the review is real or fake. People don't know the bias or motivation behind the review.

There is an issue of data overload on review sites on the Internet today. With so much information out on the Internet, it is becoming increasingly more difficult to process all of this data. People are overwhelmed.

There is an issue of being able to know what activities one's friends have done using websites on the Internet today. Websites don't provide the functionality and processes for a person to easily figure out their friends' activities: where their friends have been, what they've seen, what they've done. For instance, to which restaurants have a person's friends gone? To which do they want to go? To which movies have a person's friends seen? To which to they want to see? To where have a person's friends traveled? What did they do?

Similarly, there is an issue of being able to know what opinions one's friends have about things, such as activities they have done, services they have received, goods they have purchased, and events they have attended using sites on the Internet today. People want to know their friends' opinions about things. For a given restaurant, movie, music album, etc., what did their friends think? How did they review it? What was the overall opinion about a restaurant, movie, music album, etc. by all of a person's friends?

Continuing, there is an issue of being able to compare one's reviews of things with the reviews of one of their friends on review sites on the Internet today. People are unable to compare their reviews with the reviews of a friend. For instance, what music albums has a person reviewed, what music albums has their friend reviewed, and what is unique to the person, unique to the friend, and common to both? Further, this comparison cannot be performed for all of a person's friends in aggregate, either.

There is an issue of disparate review sites for different activities, products, and services on the Internet today. There isn't a central place to find reviews about activities, products, and services, specifically “lifestyle” activities, services, and products: restaurants, movies, music, travel, smartphone apps, books, etc. Today, people have to use multiple sites to review and find reviews about lifestyle activities.

There is an issue with the information captured about reviews on review sites on the Internet today. The composition of most reviews on the Internet fall into one of the following categories: (1) A recommendation [yes/no], and comments (optional); (2) A rating (some score on a scale of 1-5 or 1-10), and comments (optional); (3) Comments only. Additionally, many review sites offer a rating scale that is 1-5 where “3” is “OK”. This is limiting. That leaves 2 ratings for “better than OK”, which makes differentiating things that are “better than OK” difficult.

Thus, it is desirable to have reviews generated by those within a trusted community and by a leader within that trusted community. Such a community can be created by the commonality of those individuals who participate and are members of a loyalty kiosk system and network. They tend to express their loyalty and give honest evaluations because they expect the same back from others who are frequenting the same enterprises. An example of such loyalty-based communities is found in the popular site “Angie's List” where the participants rely on each other to give accurate and prompt reviews of businesses and activities.

Two common methods of acquiring consumer feedback are the use of customer surveys and the use of 1-800 numbers. However, both methods do little to mitigate common barriers to useful feedback. Surveys often receive very few responses, and in some cases the responses received are incomplete. 1-800 numbers require the consumer to copy down a phone number and then, often, will require the consumer to wait in a long phone queue.

One company that has attempted to break down these barriers is Chick-Fil-A, which has posted the cell phone number of owner/operators on signs in some stores. This eliminates some of the barriers but still requires the consumer to copy down the number or actually submit the complaint while he remains in the store, which could result in a confrontation with a store employee or owner/operator.

However, none of these provide for real-time feedback shortly after a customer has visited a store and still has the customer experience freshly in mind. Also, none have the potential of automatically tying the purchased product or service by integrating the loyalty kiosk sign-in with the purchase of a product or service and the immediate request for the customer to reply and provide a review/response, particularly where the text request for such a review/response can be targeted to the purchase, service or other event that occurred at the enterprise. This also has the benefit of being able to provide social network postings and promote dialogues as a result thereof.

In general, social network services (SNS) websites provides an online discussion process in the format of forum (such as discussion forum, bulletin board) on the website to allow the community or non-community members to participate in discussing various topics so that everybody can have their say on networks.

However, the above website forum format often shows problems, some being briefed below:

1. Currently, websites do not provide a function or service of surveying public opinion when a question is raised. If a person wishes to obtain public opinion, the person must present a question and observes what the others respond to the question. However, as the responses are usually from a handful of active others, the so-called public opinion may be easily used by the opportunists to suit specific purpose, instead of the actual public opinion.

2. Because website forums usually have many articles or posts with similar topics and they are often scattered around various website forums. If a website administrator does not organize, filter, or merge these posts regularly, the readers of the forums may be easily confused by scattered and yet overlapping information, not to mention the extra space in the website database. Even if the administrator does provide a frequently asked question (FAQ), the contents of the FAQ may still be easily affected by the administrator's bias or personal choice, instead of objective public opinions.

3. In website forums, there may be many cross-talks when a dispute arises. If a vote is conducted to settle the dispute, the voting result is also often subject to skepticism. In addition, the administrator usually can neither summarize and integrate these opinions effectively nor tracking these questions. Therefore, the records of events may simply be deleted after a period of time and the same dispute may arise again in the future.

Thus, the present invention aims to provide a method of requesting specific reaction and response data and collecting in real-time, based upon a recent loyalty kiosk engagement and customer experience, opinions and survey data, which can be employed by an enterprise in connection with its own web page and be employed on social media websites to spur engagement by others.

Technology-assisted group collaborations are now commonplace: many types of tools have been created to support and to expand upon the scope of what can be accomplished between geographically dispersed participants. Some of these tools may permit the collection of opinions from a large group of people, often using an online poll format where a series of questions are presented to participants.

This technique may be scalable with respect to the number of poll participants, but is not necessarily scalable with respect to the number of questions, or length of time necessary for each participant to express their opinions. Often, there may be tight constraints on how many and what kind of questions can be asked in a poll. An example off poll that might be unwieldy in this way may be one in which members of the public are, asked for their opinions on a variety of ideas to implement a new program on recycling. There could be dozens, hundreds, or perhaps thousands of ideas. In such a case, no respondent may be reasonably expected to express an opinion on every one of the ideas. Moreover, the opinions often bear little relationship to any recent experience that the person surveyed may have had and therefore may not be as helpful to a vendor to judge the efficacy of a current campaign, promotion or other customer experience that the vendor is trying to study and analyze.

What is needed is a way to more efficiently request and collect from individuals who have had a current experience, as determined by their logging in to a vendor specific loyalty kiosk and being asked for a reply shortly thereafter, an opinion, which can then be translated into a large group of participants and can be delivered to social media networks for even further dissemination to a larger group.

One method of securing information in real time and to associate it with a particular enterprise is to have shopping sites where individuals can shop with friends and share the experience, thus providing multiple experiences.

For example, the well-known catalog merchant Lands' End has provided a “Shop with a friend” feature on its retail website (www.landsend.com). This feature is described in an article written by Melinda Rice which appeared in the Mar. 2, 2000 edition of the Dallas Morning News and was entitled “Sites Encourage Shoppers to Bring a Friend Along”. As described in this article, the “Shop with a friend” feature is limited to linking two users together. Before the joint shopping experience, the two shoppers each select a password and agree upon a time to meet at the Lands' End website. At the appointed time, each user clicks on an icon for the feature. Based on the password, the browsers of the two users are linked and the users are allowed to “shop” together, by sharing the same web pages while talking on the phone or chatting on-line.

The Lands' End web site offers another feature, referred to therein as “Your Personal Model”. This feature allows a user to define a “3-D model” for the shopper's body based on inputs provided by the user, such as body measurements. When a garment is selected for a “virtual try-on”, an image of the garment is combined with an image based on the virtual model to provide a combined image that represents to some extent how the user might appear while wearing the garment. Because of the limited number of options available for inputting information, the virtual models bear, in general, only a small degree of resemblance to an actual image of the user.

However, neither of these has the ability to get the input from may other people based upon the real-time review/response generated by a customer in reply to a query either shortly after of even while the individual is at the vendor establishment. Thus, for example, after a person has signed in to a loyalty kiosk and is shopping at a clothing store, a message could be sent asking about the experience. By providing a review/response a customer could get input from others as to what they might be able to find, at that store that would satisfy their current purchasing need and suggestions as to other purchases that might complement their current need.

The present inventors have recognized the desirability of increasing the opportunities to obtain from loyal customers real-time input and review/responses to specific queries in order to enhance the shopping experience, modify or enhance the shopping experience and create a further loyalty bond with a customer by soliciting their review/response to show that the vendor “cares” about their customers and want to know what they think.

### BRIEF SUMMARY OF THE INVENTION

In one aspect, the present invention related to a computer implemented system and method for creation of a digital, collaborative review platform, network and publication system through a loyalty based kiosk platform for obtaining reviews from select customers in response to a text inquiry. The select customers may obtain loyalty credits or other incentives for providing reviews within a period of time and may become leaders and followed persons. The results of the reviews may be further used to obtaining information about members of a consumer base, may be filtered, analyzed, compiled and otherwise employed prior to publishing and may be posted to a multiplicity of social network sites or separately published as a standalone platform/site which may only be accessed by loyalty kiosk members.

In another aspect, the present invention related to a computer implemented system and method for creation of a digital, collaborative review platform, network and publication system through a loyalty based kiosk platform for obtaining reviews from a group of customers in response to a text inquiry where those customers are part of a loyalty kiosk platform.

The present invention relates to the field of marketing and the delivery of text messages following the entry of data by a customer via a loyalty kiosk and associated non-transitory computer-readable storage media having computer-executable instructions embodied thereon situated within a business environment. The customer data and loyalty kiosk check-in is used in SMS/text generation campaigns to instill loyalty in the customer and obtain review/response data from the customer that can be employed in conjunction with a social media and/or loyalty network series of postings. The system and method further provide dissemination of the review/response campaigns through social network interfaces and data/status updates of the review/response campaign based on review/response designated triggers, filters and engines.

In another aspect, the system and method further provide for the dissemination of marketing campaigns through social network interfaces and data/status updates of the market campaign based on business designated triggers.

In yet another aspect, the present invention provides for the creation of a cohesive marketing plan and technology to identify loyal customers and to maintain that loyalty by engaging them to provide review/responses to real-time inquiries that are tied to recent customer experiences at the vendor location, and to provide incentives and rewards for providing those review/responses so that the loyal customers will continue to be engaged with the enterprise.

It is a further aspect of the present invention to provide a method and system in the field of interactive marketing and data acquisition to permit such marketing in particular, but not limited to, in a marketing and data acquisition system using short message services (SMS) provided on mobile devices such as cell phones or other telecommunication systems permitting SMS or other short code transmissions.

In yet a still further aspect, the invention provides a method and system for generating review/responses based upon the previous physical location of a customer proximately located to a loyalty kiosk, within a defined but variable period of time from the customer's checking in to the loyalty kiosk, by generation of a marketing query and request for a critique of a customer's experience at the enterprise associated with the specific loyalty kiosk.

It is yet another aspect of the present system and method of the invention to solicit customers to provide personal data, in compliance with regulations and laws relating to the use of such personal data, to enable merchants to effectively engage customers and provide appropriate messaging to get them to provide review/response data and information.

It is an object and feature of this invention to provide a system to develop and maintain content in one or more databases of subjects (e.g., a product, a service, a leisure activity, an experience or a topic) which can be accessed by participants within a loyalty platform infrastructure, which content can be easily and uniquely searched by users to help them make informed decisions about the database subjects that are particularly relevant to their needs and desires.

It is another object and feature of this invention to provide a system for soliciting and collecting user reviews regarding the database subjects, based upon loyalty kiosk activation and temporally related requests for reviews and for utilizing the user opinions and/or reviews to support database searches and more informed decision making about the subjects.

Yet another object and feature of the invention is to enable people within a loyalty network, with diverse backgrounds and qualifications, but who have been selected to be part of a leader board system, to contribute content to the database, and to express opinions or reviews in the form of ratings of database subjects, all in a way that improves the usefulness and quality of the information being added or rated.

It is still another object and feature of the invention to reduce the need for centralized control and management of the database content by having multiple engines and algorithms to evaluate, parse and compile the review content to maintain the quality of the database content and the performance of the contributors.

It is another object and feature of the present invention to provide a system for recruiting loyalty platform participants to want to create, maintain and provide reviews through the loyalty platform infrastructure on a variety of consumer decision support categories related to the enterprise participants in the loyalty platform, such as leisure experiences, products and services.

Yet another object and feature of the invention is to attract new loyalty participants and develop user loyalty, through personal involvement and content contribution, by way of the use of rewards of the success of the loyalty platform.

It is another object and feature of the present invention to provide a system to compensate contributors for their efforts by making reviews by others highly informative and relevant to the loyalty platform enterprises and the products and services provided so that each loyalty platform participant will ensure a dynamic, comprehensive and accurate database of information for use by other loyalty platform participants.

Additional objects, features, and advantages of the invention will be set forth in the description that follows and in part will be apparent from the description or may be learned by practice of the invention. The objects, features and advantages of the invention may be realized and obtained by means of the instrumentalities and combinations pointed out in the subsequent specifications, drawings and appended claims.

It is yet a further aspect of the present system and method of the invention to solicit customers to provide personal data, in compliance with regulations and laws relating to the use of such personal data, to enable merchants employ the review/response to provide posts for social media and create discussions and positive reaction to a vendor and the experience created by that vendor and behave in a particular manner and thereby earn rewards and incentives by such behavior.

In another aspect of the aspect of the present system and method of the invention a solicit customers is solicited, via SMS or other communication methodology, to provide review/responses and thereby earn rewards and incentives by such the review/response, regardless of whether it is positive or negative.

In a further embodiment and aspect, the system provides a series of devices, methods and tools for aggregating opinions from a group of review/responders. In an embodiment, each review/responder may be asked to answer a small subset of questions, where each subset of questions presented to a participant may be different from a subset of questions posed to another participant. Data processing system implemented methods, systems and tools may be used to prepare each subset of questions to be asked, based on which questions require a larger sample of opinions, and to aggregate the subsets of opinions to infer an aggregate opinion for the group. This may significantly reduce or eliminate the need to subject a participant to the onerous task of expressing an opinion on each one of a large number of questions that may be collected from a group of review/responders.

In another embodiment, the system may determine a measure of confidence for each question by determining a confidence interval calculated from the distribution of numeric values of the received opinions.

In a further embodiment, the method further comprises: ranking the questions based on their aggregated opinions; selecting a region of interest in the ranked list of questions; and selecting a question to be posed to a successive participant from the region of interest with a preference for questions having a wider confidence interval.

In yet another embodiment, the method further comprises posing questions to successive participants until the confidence intervals for the questions in the region of interest have reached a desired confidence interval.

In another embodiment, the system and method further comprises: providing a number of predefined categories, and requesting from a customer an opinion and tabulating the number of participants that provide a review/response in each predefined categories, and calculating a review/response efficacy and value for each category.

In yet a further embodiment, the system and method further comprises, for each question, selecting based on a review/response efficacy determinant, the questions that are most likely to elicit a review/response and the nature of that response.

In an aspect of the invention, there is provided a data processing system for aggregating opinions on a plurality of questions from a plurality of participants, comprising: means for providing to each participant a question, and requiring for each question an opinion from the participant that may be expressed as a numeric value; means for aggregating, for each question, opinions received from the participants, and calculating a value representative of an aggregated opinion of the participants; means for calculating for each question, from the distribution of numeric values of the received opinions for the question, a measure of confidence in the aggregated opinion; and means for providing, for a successive participant, a question selected in dependence upon the calculated measure of confidence in the aggregated opinion.

The systems, methods and apparatuses described herein provide for consumer feedback, input and customer retention management, allowing feedback providers (consumers and customers) to effortlessly provide inputs using electronic devices, such as mobile devices. According to the present disclosure, feedback providers are able to provide feedback to a wide variety of feedback recipients, and an application running on the user's device may automatically locate and deliver these inputs via the correct communications channel associated with a specific feedback recipient location. Feedback recipients such as businesses owners will be able to manage the inputs, listen, read voice to text translation, and respond to inputs with emails and/or coupons. Feedback recipients such as businesses/owners may be able to use the inputs to transmit positive and negative comments back to employees, add comments, set priorities for internal uses, and extract transcripts to combine with existing analyses of customer complaints and service measurements.

In yet another aspect of the invention, a customer visiting a participating merchant who is advertising through the system and has a loyalty kiosk will be solicited to check into the kiosk and will thereafter receive a targeted message via SMS or other messaging methodology. The message will thank them for the visit to the merchant, thus acknowledging their loyalty, and create a new reward for a response to the message's request of, for instance, providing a review of the visit experience.

The invention further relates to the creation of one or more location based offers or rewards in which a customer is solicited to check into the kiosk and will thereafter receive a targeted message via SMS or there messaging methodology based upon the perceived location of the kiosk. The message will ask the customer for a response and, upon obtaining that response will generate a reward for the customer and will add the review to any of a number of predetermined area that relate to the marketing campaign, such as a Facebook posting, loyalty network website or other advertiser designated location.

The invention further relates to the aggregation of data from multiple input sources to generate automated personalized marketing campaigns and functions via one or more non-transitory computer-readable storage media having computer-executable instructions embodied thereon, wherein when executed by at least one processor, the computer-executable instructions cause the at least one processor to acquire data relative to a customer to permit the generation of one or more loyalty/reward messages to the customer based on the customer's habits, triggers and inputs.

The system and method of the present invention further provides computer-executable instructions within the non-transitory computer readable storage media to permit the further requesting of customer data, the loading of customer data and the evaluation of the customer data in order to permit the generation of appropriate loyalty/reward messages to the customer.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is an illustrative embodiment of an interactive Reply, Review and Publish marketing system in accordance with the method, system and programs of the present invention.

FIG. 2 is a block diagram that illustrates a preferred embodiment of an interactive Reply, Review and Publish marketing system for securing and processing customer data, actions review/responses and reactions in accordance with the method, system and programs of the present invention.

FIG. 3 is a high level flowchart and block diagram illustrating a system and method for individualizing, delivering and processing messages and for otherwise employing an interactive. Reply, Review and Publish marketing system for securing and processing customer data, actions, review responses and reactions in accordance with the method, system and programs of the present invention.

### DETAILED DESCRIPTION OF A PREFERRED EMBODIMENT

As used herein, “question” or “question data” means the question or data representing the substantive content of one or more questions having a user-intended general substantive meaning, irrespective of formatting or other presentation difference(s), security or communication protocol or other technical code or hardware-based content difference(s), computer or human language difference(s), dialect difference(s), exact wording difference(s), particular word choice difference(s), grammatical difference(s) or idiomatic difference(s).

As used herein “identical question data” means question data that are identical only to an extent equal to or greater than what is required substantively to communicate the question data to a user.

As used herein, “answer’ or “answer data” means any electronically communicated information that represents one or more of textually-input, orally-input, and video-input substantive content of one or more user responses to at least one question, the user response(s) having a user-intended general substantive meaning, irrespective of formatting or other presentation difference(s), security or communication protocol, or other technical code or hardware-based content difference(s), computer or human language difference(s), dialect difference(s), exact wording difference(s), particular word choice difference(s), grammatical difference(s) or idiomatic difference(s).

As used herein “identical answer data” means answer data that are identical only to an extent equal to or greater than what is required substantively to communicate the answer data to a user.

As used herein, “collaboration data” means any electronically communicated information that represents one or more of textually-input, orally-input, and video-input substantive content of one or more user comment regarding, question about, suggestion for, or revision of any user's answer data, the one or more user comment regarding, question about, suggestion for, or revision of any user's answer data having a user-intended general substantive meaning, irrespective of formatting or other presentation difference(s), security or communication protocol or other technical code or hardware-based content difference(s), computer or human language difference(s), dialect difference(s), exact wording difference(s), particular word choice difference(s), grammatical difference(s) or idiomatic difference(s).

As used herein “identical collaboration data” means collaboration data that are identical only to an extent equal to or greater than what is required substantively to communicate the collaboration data to a user.

As used herein, “selection data” means any electronically communicated information that represents one or more of textually-input, orally-input, and video-input substantive content of answer data (or revised answer data) preference or answer data (or revised answer data) ranking, answer data (or revised answer data) preference or answer data (or revised answer data) ranking having a user-intended general substantive meaning, irrespective of formatting or other presentation difference(s), security or communication protocol or other technical code or hardware-based content difference(s), computer or human language difference(s), dialect difference(s), exact wording difference(s), particular word choice difference(s), grammatical difference(s) or idiomatic difference(s).

As used herein “identical selection data” means selection data that are identical only to an extent equal to or greater than what is required substantively to communicate the selection data to a user.

As used herein “responsive data” means any digitally communicated information that represents one or more of textually-input, orally-input, and video-input user response(s) to at least one question broadcast to the user's device caused and initiated by transmission of at least one set of question data input into an administrator device.

Some embodiments described herein involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The above examples are exemplary only, and thus are not intended to limit in any way the definition and/or meaning of the term processor.

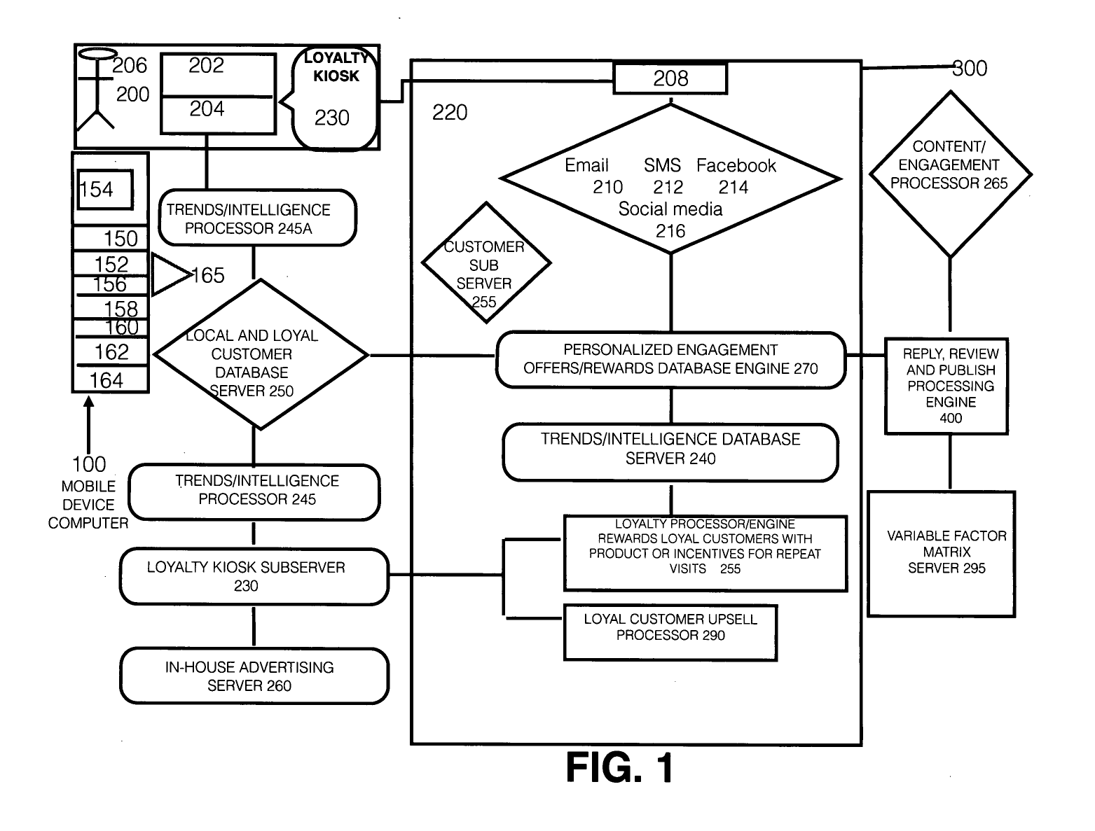

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. For clarity of explanation, the illustrative system embodiment is presented as comprising individual functional blocks (including functional blocks labeled as a “processor”, “server” or “engine”). The functions these blocks represent may be provided through the use of either shared or dedicated hardware, including, but not limited to, hardware capable of executing software. For example, the functions of one or more processors presented in FIGS. 1-3, may be provided by a single shared processor or multiple processors. Use of the terms “processor” or “server” or “engine” should not be construed to refer exclusively to hardware capable of executing software.

In one or more exemplary embodiments provided herein, the programmed instructions may be generated as a group of co-operative software modules, each having its dedicated functions. The descriptions of such modules will allow one of ordinary skill in the art to readily appreciate the programming instructions required for implementing the disclosed processes herein. However, the programmed instructions themselves can be implemented in wide array of ways, depending, for example, on the operating system and software applications/environments selected, as well as on designer preference.

Such electronic or computing devices also typically include a memory coupled to the processor. The memory may include one or more tangible, non-transitory, computer readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory.

The terms “processor” or “server” or “engine” as used herein are broadly defined as one or more processing units of any type for performing all arithmetic and logical operations and for decoding and executing all instructions related to facilitating an execution of the various methods of the present invention. Additionally, the term “memory” as used herein is broadly defined as encompassing all storage space in the form of computer readable mediums of any type.

The methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, such as a firmware, physical and virtual storage, CD-ROMs, DVDs and another digital source such as a, network or the Internet, as well as yet to be developed digital means, with the sole exception being a transitory, propagating signal.

In the one form of the present invention, the system comprises a processor and a memory storing data and information about the customer and/or the merchant and/or the campaign specifics and the data related to each of those along with a network communication system storing customer information that is related to each merchant with whom the customer interacts. The processor and memory store instructions operable with the processor for executing an interaction among the distinct modules to facilitate a communication between the customer and the campaign via SMS or other messaging protocol and generation of appropriate rewards and incentives for defined actions.

The instructions are executed to permit the communication and to obtain at least some information back from the customer in order to provide feedback both as to the actions of the customer and to maximize the effectiveness of the messaging. The information that is received from a client is employed to update the campaign profile relative to that customer in order to individualize the messages as well as generating campaign data to permit the merchant to better manage the campaign and influence future campaigns and the language and motivational parameters of the current campaign.

Illustrated in FIG. 1 is one implementation of a computing device 100 such as any computing device described herein. Computing device 100 can include a central communication bus 150 that communicates with each of the components included in the computing device 100. These components can include: an input/output (I/O) control 152; a display device 154; a network interface 156; a storage repository 158; a main processor 160; cache 162; and memory 164. The main processor 160 can include elements such as one or more I/O ports, or a memory port 165.

Further referring to FIG. 1, and in more detail, in some implementations the computing device 100 can be any computing device 100 having a processor 160. The computing device 100 can be a mobile device such as a laptop, netbook, smart phone, electronic reader, cell phone, personal digital assistant, tablet computer or any other hand-held computing device comprising a processor 160. In some implementations, the computing device 100 can be any hand-held mobile device able to carry out the methods and systems described herein. In some implementations, the computing device 100 can be a computer, a client computer, a server, or any other machine comprising a processor 160 able to execute computer readable instructions. The computing device 100, in some implementations, can be referred to as a computer, a computing machine, a machine, a device, a mobile device, or a mobile device.

The processor 160 included in the computing device 100 can be referred to as a central processing unit (CPU) or as a main processor. In some implementations, the processor 160 can include a single processing core, while in some implementations the processor 160 can include multiple processing cores. When the processor 160 includes multiple processing cores, the cores can execute in parallel and can access a shared memory location or individual memory locations assigned to particular cores. In some implementations, the computing device 100 can include multiple processors 160. When the processor 160 includes multiple processing cores or multiple processors, the processors can execute a single instruction simultaneously on multiple pieces of data (SIMD), or in some implementations can execute multiple instructions simultaneously on multiple pieces of data (MIMD).

In one implementation, the processor(s) 160 can be any processor. In some implementations, the processor(s) 160 can be any combination of a microprocessor, a microcontroller, programmable logic gates, or any other processor. The processor 160, in some implementations, can further comprise a graphics processing unit (GPU) which can include any combination of hardware and processor-executable instructions for processing graphics data and graphics commands. In some implementations, the processor 160 can further comprise a graphics engine or any other processing engine.

Referring again to FIG. 1 there shown a customer 200 at a point of transaction device 202 having a user interface 204 within a network communication system 220. The point of transaction device 202 is ideally located within a merchant establishment 206. A telecommunications system 208 is interconnected to a series of communications means such as e-mail 210, SMS 212, Facebook pages 214 and other social media/telecom modulated systems 216.

A loyalty kiosk 230 is advantageously disposed in proximity to the point of transaction device 202 in order to permit the customer 200 to see the various campaign information which is packaged and displayed appropriately in the loyalty kiosk 230 of the particular merchant establishment 206. Thus, for example, if a customer 200 has gone into a merchant establishment 206 where they generally go to purchase clothes, appropriate campaign information will be displayed at the loyalty kiosk 230 so that the customer 200 will see it and will be prompted to enter their telephone number and interact with the loyalty kiosk 230.

As a further part of the system, the loyalty kiosk 230 may also request additional customer data from the customer 200 at the same time that it is displaying the campaign information to that customer. Thus, by way of example, the loyalty kiosk 230 may ask for an update of the customer 200 E-mail address or suggest that an incentive or other discount maybe available which is related to the customer 200 current purchase.

At the time that the customer 200 enters their telephone number and customer data, the system 220 will enter the telephone number and related data into both a database 250 of local and loyal customers and provide individual database of personalized engagement offers and rewards through a sub-database 255 which is designed for the individual customer 200. The sub database 255 maybe a part of the main database 250 or maybe a register maintained separately from the main database 250.

Once the customer 200 enters their telephone number, it permits a main trends/intelligence processor 245 to determine when the customer 200 had last been at the merchant establishment 206, what their prior purchase had been and to otherwise permit the aggregation of data on that customer 200. As a further part of the system, a core database server 300 structure aggregates data from multiple input sources which relate to the customer 200 who has entered their telephone number.

Thus, by way of example, the core database structure 300 may determine that the customer 200 has not been purchasing clothes recently as seen by the fact that the customer 200 has not frequented a clothing store to which they are loyal. The system may determine that the customer 200 has almost earned a reward in the particular store and thereby would send an “Almost Earned Reward” text/notification to remind the customer of their participation within that loyalty program and entice them to continue to participate.

Similarly, the core database structure of the SMS marketing engine 300 may determine that a customer 200 has been inactive in purchasing at any of the number of stores who are participants in the intuitive marketing system. The core database 300 would then initiate an “Inactive Customer” text/notification message to remind that customer 200 that they have not interacted with the system for a specified period of time and remind them of the benefits and rewards that come with participation within the loyalty program, thus enticing them to come back to the store or stores are participating in the loyalty system.

The core database structure of the SMS marketing engine 300 may also determine that a customer 200 should be sent a personal SMS text requesting information concerning the customer's experience at the vendor and a review/response in connection with that experience. The personalized engagement offers/rewards database engine 270 may generate any one of a series of indications to the Reply, Review and Publish processing engine 400 that a text or other small message format request should be sent to the customer 200.

The Reply, Review and Publish processing engine 400 may advantageously have time parameters associated with the interval between which a customer 200 signs into a loyalty kiosk 230 as a vendor location at the time when a message should be sent. Thus, by way of example, if a customer is in a clothing store it may be advantageous to send a message during the time that the customer is actually in the store whereas if the vendor is a supermarket it may be more advantageous to send a message after the shopping experience has finished.

A variable factor matrix server 295 maybe employed in connection with the Reply, Review and Publish processing engine 400 to determine various factors besides time interval which should be used in connection with any given text message. So variables may include the nature of the text message, whether it should be brief or more detail, whether it should be merely a request asking generally about the customer 200 experience at the vendor or whether it should be more detailed to listen specific information about that experience. Each of these, and other factors, maybe employed in connection with the variable factor matrix server 295 and the Reply, Review and Publish processing engine 400 to obtain both a favorable reply and usable data in the review/response.

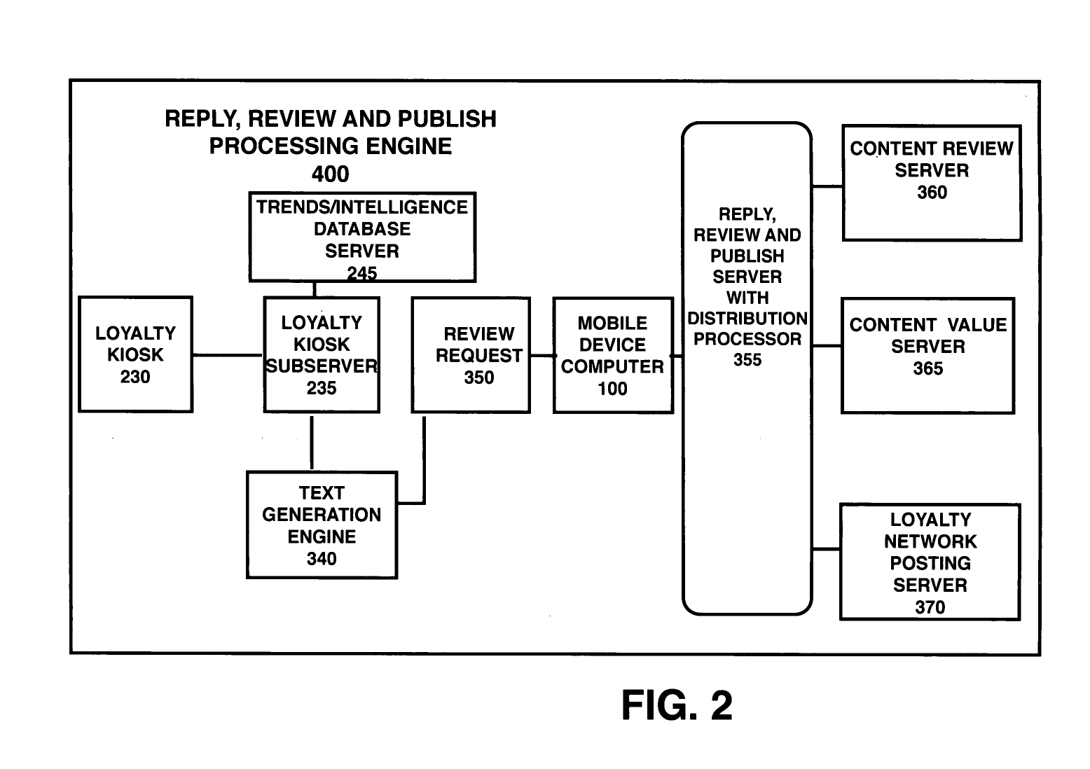

Referring to FIG. 2, there is illustratively shown a block diagram that illustrates a preferred embodiment of an interactive Reply, Review and Publish marketing system and engine 400 for securing and processing customer data, actions review/responses and reactions in accordance with the method, system and programs of the present invention. Once a customer 200 enters a participating enterprise that has a loyalty kiosk 230 and enters their information to addendum for themselves, the loyalty kiosk provides that information to the loyalty kiosk sub-server 235. The loyalty kiosk sub-server 235 transmits the input information to the trends/intelligence database server 245. The trends/intelligence database server 245 may then perform certain operations relating to the processing of the data and may perform these operations in response to the Reply, Review and Publish processing engine executing software instructions contained in a computer readable medium such as a memory. A computer readable medium may be defined as a logical or physical memory device. A logical memory device may include the space within a single physical memory device, or be spread across multiple physical memory devices.

The trends/intelligence database server 245 they provide an output to a text generation engine 340 with instructions to create a text message for delivery to the customer 200. The text message may be as simple as a thank you for visiting the particular enterprise with a simple request that the customer 200 provide a quick review of their visit to earn additional reward points from the vendor they are reviewing.

Alternatively, the request may be tied to the service that the customer 200 received at the vendor or may relate to the customers satisfaction with the merchandise offerings available at the vendor. The nature and quality of the text message may vary both with the type of vendor that was frequented and the information provided by the customer in initially registering to be part of the loyalty program. The text message may also have a temporal component requesting that the customer 200 respond within a certain period of time in order to obtain additional points from the vendor they are reviewing.

The text generation engine 340 may send an instruction to a review request server 350 to deliver the generated text to the mobile device computer 100. The review request server 350 may implement the instruction by one or more hardware elements of the review request server 350 or by one or more software elements in combination with one or more hardware elements of review request server 350. The review request server 350 million direct with the mobile device computer 100 by transmitting the text message.

If the customer 200 provides a review/response as a result of the text message received by the mobile device computer 100, the message is transmitted to and received by a Reply, Review and Publish server with distribution processor 355. The Reply, Review and Publish server with distribution processor 355 may interact with one or more of the distribution mechanisms designated on the enterprise in connection with the platform provider. Thus, by way of example, the Reply, Review and Publish server 355 advantageously interact with a context relating engine 425 to ensure that the review is related to both the query and the enterprise and a loyalty network posting server 370. The above are not meant to be exclusive and are merely illustrations of the distribution and verification mechanisms that may be employed in connection with the instant invention.

The Reply, Review and Publish server 355 may also store review/responses regarding a particular vendor or enterprise and may include, for example, a customer's comments regarding a particular circumstance which occurred during the visit or a particular individual or other specific that may be relevant both for future requests and to provide the vendor with the data that it may employ four more effective marketing or customer relations. The Reply, Review and Publish server 355 may also parse the portions of the review/response to select key or important words that it may advantageously use to reformulate requests in the future or determine whether to deploy the review/response to one or more of the designated distribution mechanisms.

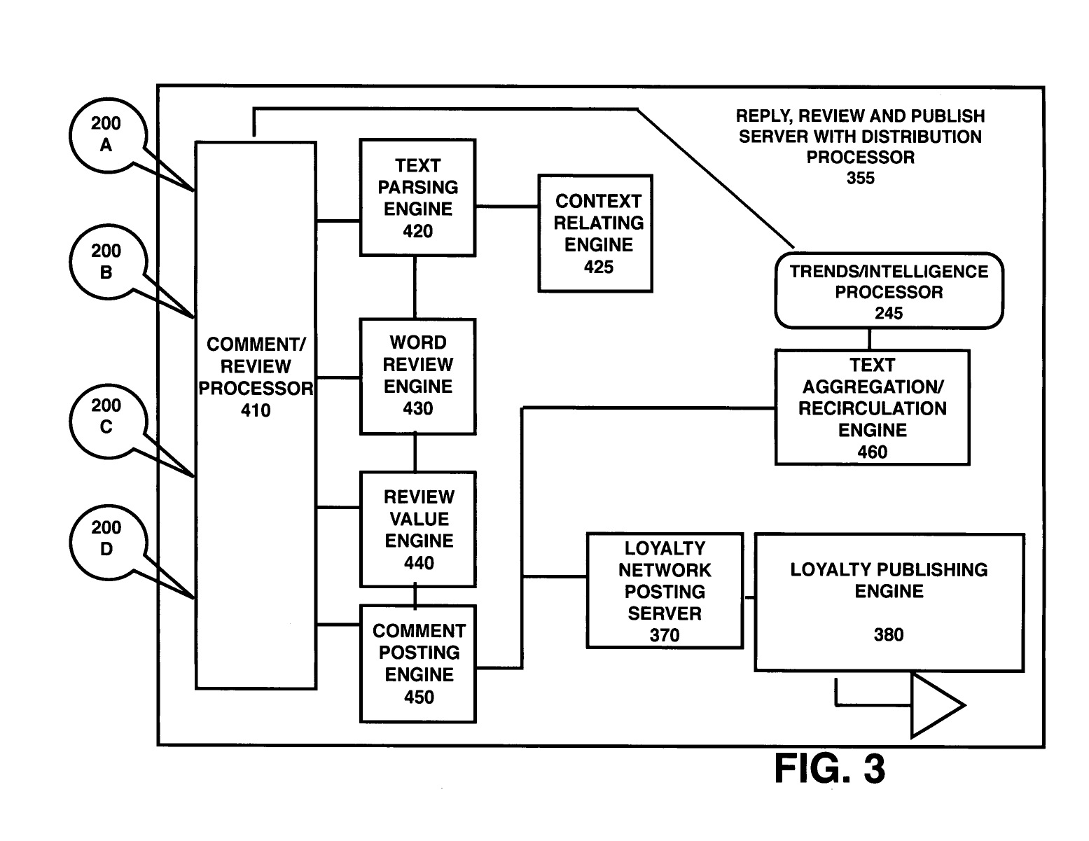

Referring to FIG. 2 and FIG. 3, there is illustratively shown a high level flowchart and block diagram illustrating a system and method for individualizing, delivering and processing messages and for otherwise employing an interactive Reply, Review and Publish marketing system for securing and processing customer data, actions, review responses and reactions in accordance with the method, system and programs of the present invention.

The Reply, Review and Publish server 355 but advantageously be comprised of a comment review processor 410 which operates in conjunction with and may deliver comments and information to a series of one or more engines that may not and maintain a mapping of review/responses received from multiple customers 200. For illustrative purposes only four such customers 200 have been depicted in FIG. 2 and designated 200 A, 200 B, 200 C and 200 D.

Each of the customers 200 may provide a review/response to a request from the personalized engagement offers/reward database engine 270. Each of the review/responses may be received by the comment/review processor 410 which advantageously communicates with one or more engines to evaluate the nature and quality of the review/response.

The comment review processor 410 may transmit the review/response to a text parsing engine 420. The text parsing engine 420 may operate a computer to perform linguistic analysis by any one of a number of parsing techniques including splitting an input text into words and sentences.

The text parsing engine 420 may also communicate with a context relating engine 425. The context relating engine 425 may employ a series of context related parameters to evaluate the reply/response. Examples of context-related parameters include, but are not limited to, determining the frequency of visits to a location being reviewed, detecting time spent by a user reviewing the request and the location, determining time of the day at which the request and the location is reviewed, determining completeness of the review, determining consumability of the request and the location that is being reviewed, determining user's past behavior while reviewing similar requests and locations, determining location of the user with regard to the loyalty kiosk and determining the specificity of the review.

The comment review processor 410 may also transmit the review/response to a word review engine 430 which may, for each sentence and in conjunction with a word value engine 440, compare words or phrases in the sentence with known phrases stored in a database, as illustratively follows: for each word in the sentence, comparing its value and the values of the words following it with the values of the words of stored phrases, starting with the longest stored phrase that starts with that word, and working from longest to shortest; in the event a match is found between the value of two or more consecutive words and the value of a stored phrase, labelling the matched two or more consecutive words with a determination that describes the matched value and indicates whether it is:

a. responsive to the request;

b. negative;

c. positive; and,

d. contains such other variables as are important to the enterprise in determining whether to disseminate the reply/response.

The above word review is merely meant to illustrate one review methodology which may be employed by the word review engine 430 either by hardware or by software in conjunction with hardware.

The word value engine 440 may determine that the value used in the comparison process may involve the literal spelling of the words, the sense-meaning of the words, the grammatical use of the words or other attributes of the words. The parsing is satisfied by use of any one of these values, or by adding a second or third tier of comparisons involving one or more of the other values. By matching word sequences this way, both grammatical and semantic content can be addressed at the same time.

The comparison process may comprise more than the comparison of the values of words, for instance it might include conditional requirements dependent on words around the phrase. For example the outcome of the comparison may be affected by a word preceding the phrase being negative, or an adjective.

The comparison process may be performed according to a predetermined order. Similarly, phrases and words in the text may be converted according to a predetermined conversion order associated with the phrases and words. This order could run forwards, matching phrases from the beginning of the sentence; or backwards by matching a sentence first and the clauses and phrases subsequently.

The parsing engine 420, word review engine 430 and review value engine 440 perform linguistic analysis by emulating the mental processes used by humans when reading text. They may use a combination of hierarchical pattern storage, sequenced parsing layers and bidirectional pattern matching to convert text-based human languages into their constituent grammatical parts. These techniques mimic functions seen primarily in biological brains. They may convert text to its hierarchical patterns, either by matching words to phrases, then phrases to clauses, then clauses to sentences or in reverse, by matching a sentence to clauses, and then clauses to phrases. It may also be advantageous to provide that the longest patterns are matched ahead of shorter ones, while maintaining the flexibility for shorter phrases to be matched first when needed, thus seeking to ensure that the precise nature and content of the review/response is determined and understood before it is disseminated. This also caters to matching idiomatic phrases and names ahead of grammatically-based phrases.

The information generated by each of the engines is review by the comment review processor 410 and, upon determination that the review/response is appropriate for dissemination is delivered to a comment posting engine 450 for delivery to one or more distribution points. As is illustrative shown in FIG. 3, the comment posting engine 450 may deliver the review/response to an enterprise website 360, and enterprise Facebook page 214 and/or and loyalty network posting server 370. It will be appreciated that the comments posting engine 450 may also disseminate the review/response to other locations for distribution, Including delivery to a loyalty distribution engine 380 which can then distributed to other Facebook pages, websites weekly e-mails, mobile pages and the like.

As a further part of the Reply, Review and Publish processor system 355, a text aggregation/recirculation engine 460 maybe employed to store review/responses either in their native form for in any one of the parsed, reviewed or valued forms generated by the respective engines 420, 430 or 440. The text aggregation/recirculation engine 460 may transmit its information to the trends/intelligence processor 245 in order to permit it to update and revise the actions of the comments/review processor 410 and provide modifications to the variable factor matrix server 295 and content engagement processor 265 thereby providing feedback to the personalized engagement offers/reward database engine 270.

As a further part of the Reply, Review and Publish processor system 355, the aggregation/recirculation engine 460 may filter the number of times that an establishment or enterprise is reviewed, ascertain and limit the number of times that a loyalty platform customer may review a specific enterprise by not asking the customer more than once every cycle period of time (which is variable) and designate an individual to be a “leader” or “preferred person” whose reviews are more often sought and secure greater respect.

As a further part of the Reply, Review and Publish processor system 355, the aggregation/recirculation engine 460 may send a text asking for a review after an interaction by a loyalty platform customer with a market specific campaign or may send a text asking for specific information rather than a review.

The following terminology is used throughout this disclosure:

As used herein, a “user” may be used interchangeably with “customer” 200 and can be, in some implementations, a user of a mobile device 100 where the user can execute applications on the mobile device 100, and participate in the receipt of text or other messages, send review/responses in reply to the messages and participate in reward programs presented to the user via the mobile device 100. Ideally, the user can be a consumer of goods who has just employed a loyalty kiosk and has been engaged with a vendor or enterprise and is willing to review/respond to a request for information about that enterprise.

As used herein, “research” can be, in some implementations, information obtained from a loyalty kiosk customer that can be used to determine the experience of that customer within a vendor, enterprise or be used to assist in generating market data for the vendor and possibly others who also have loyalty kiosks and participate in the loyalty based system of the invention.

As used herein, a “rewards program” can be, in some implementations, a program that provides rewards to a consumer when that consumer behaves in a particular manner. The reward can also be a function of the action by a customer who has checked into a loyalty kiosk in providing a review/response in reply to an inquiry, following the check-in. The rewards can be any of the following: discounts; rebates; points; free items; or any other reward. In some implementations, a rewards program fosters loyalty between the consumer and the vendor that provides the reward. In some implementation the rewards program can be referred to as a consumer rewards program.

As used herein, a “loyalty kiosk location” can be the location of a loyalty kiosk 230 on a coordinate map or at a vendor location. In some implementations, the location can be a set of coordinates such as a set of Cartesian coordinates, whereas in others it will be a location within a server or processor that defines the loyalty kiosk.

As used herein, a “vendor” or “enterprise” can be a third party that produces or provides a product or a service. In some implementations, the vendor can interact with Reply, Review and Publish processor to provide consumers with rewards and/or to obtain information about a consumer's behavior in providing a review/response with regard to the vendor's product/service and thereafter using that review/response within the vendor's website, or on social media.

In general overview, the present disclosure is directed to, among other things, obtaining information regarding a vendor's enterprise, obtaining information regarding a user, and/or compensating a user for providing the review/response. From a mobile device the customer may receive the inquiry from the system to provide a review/response. The mobile device may send the review/response to a server. A server may receive the review/response and determine whether it is positive or negative and may determine whether to post the review/response to the vendor's website or distribute it to various social media networks. The server may determine the information in the review/response for acceptability and/or provide rewards/incentive to the user if the information is acceptable. The server may perform similar steps for research programs, both on behalf of the vendor and on behalf of the system participants in general to provide a more efficacious marketing and loyalty platform.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An automated review publishing loyalty marketing system comprising:
a. a loyalty kiosk situated at a merchant establishment that communicates with a loyalty recipient customer over a network interface upon activation by said loyalty recipient customer;
b. a processor having a memory for storing profile and loyalty activity data for at least one loyalty recipient customer;
c. loyalty kiosk activation means through a customer unique identifier;
d. acquiring means to secure and transmit a the location of the activated loyalty kiosk;
e. a processor capable of determining the loyalty recipient customer's loyalty kiosk activation;
f. a variable factor matrix server associated with the processor capable of selecting an appropriate request for a response from the loyalty recipient customer;
g. means to transmit the request for a response to the loyalty recipient and obtain a response therefrom;
h. a server to accept and process a response received as a result of the request to the loyalty recipient customer;
i. a comment review processor capable of reviewing a response and ascertaining whether to distribute the response within the loyalty platform system; and,
j. a comment posting processor capable of distributing the response upon instruction from the comment review processor or otherwise employing the response as directed and/or aggregating the responses of loyalty recipient customers for publication within the loyalty platform system.

2. An automated review publishing loyalty marketing system of claim 1 wherein the request for review/responses is temporally related to the activation of loyalty kiosk by the loyalty recipient customer.

3. An automated review publishing loyalty marketing system of claim 1 wherein an award benefit is provided to the loyalty recipient customer upon providing the review/response.

4. An automated review publishing loyalty marketing system of claim 1, additionally comprising means to parse the review/response.

5. An automated review publishing loyalty marketing system of claim 1, additionally comprising means to review the substance of the text of the review/response.

6. An automated review publishing loyalty marketing system of claim 1, additionally comprising means to value the substance of the text of the review/response.

7. An automated review publishing loyalty marketing system of claim 1, wherein the personalized request for review/response is transmitted in SMS format to the customer supplied address and is delivered to a mobile communication device.

8. An automated review publishing loyalty marketing system of claim 1, wherein the comment posting processor distributes the response in accordance with dynamically alterable determinants and instruction to publish one or more of the reviews to a site capable of being accessed by other loyalty platform parties.

9. An automated review publishing loyalty marketing system of claim 1, wherein the comment posting processor aggregates the responses of loyalty recipient customers for use by one or more merchant establishments.

10. An automated review publishing loyalty marketing method implemented by a loyalty recipient customer comprising:
a. activating a loyalty kiosk situated at a merchant establishment by the loyalty recipient customer to communicate over a network interface upon activation by said loyalty recipient customer;
b. storing profile and loyalty activity data for at least one loyalty recipient customer;
c. activating the loyalty kiosk through a customer unique identifier;
d. acquiring and transmitting the location of the activated loyalty kiosk to a processor;
e. validating the loyalty recipient customer's activation;
f. selecting an appropriate request for a response from the loyalty recipient customer;
g. transmitting the request for a response to the loyalty recipient and obtaining a response therefrom;
h. accepting and processing a response received as a result of the request to the loyalty recipient customer; and,
i. publishing the response for access by other loyalty platform customers.

11. The automated review publishing loyalty marketing method of claim 10 further comprising the step of temporally relating the request for review/responses to the activation of loyalty kiosk by the loyalty recipient customer.

12. The automated review publishing loyalty marketing method of claim 10 further comprising determining by a variable factor matrix server the award benefit and temporally linking said benefit to a time for receipt of the review/response.

13. The automated review publishing loyalty marketing method of claim 10 further comprising parsing the review/response.

14. The automated review publishing loyalty marketing method of claim 10 further comprising reviewing the substance of the text of the review/response.

15. The automated review publishing loyalty marketing method of claim 10 additionally comprising valuing the substance of the text of the review/response.

16. The automated review publishing loyalty marketing method of claim 10 additionally comprising delivering a personalized request for review/response in SMS format to the customer supplied address and is delivered to a mobile communication device.

17. The automated review publishing loyalty marketing method of claim 10 additionally comprising distributes the review/response in accordance with dynamically alterable determinants and instruction to one or more sites capable of being accessed by loyalty platform participants.

18. The automated review/response marketing method of claim 10 additionally comprising aggregating the responses of loyalty recipient customers for use by one or more merchant establishments.
